(19) United States
(12) Patent Application Publication
(10) Pub. No.: US 2004/0191385 A1
(43) Pub. Date: Sep. 30, 2004

(54) Composition for stabilizing pink color of fresh large cardamom and a process for stabilizing the pink color of large cardamom

(75) Inventors: Jarpla Pura Naik, Mysore (IN); Sathyagalam Ranganatha Desikacharya Sampathu, Mysore (IN); Kambadoor Nagaraja Rao Gurudutt, Mysore (IN)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Council of Scientific and Industrial Research, New Delhi (IN)

(21) Appl. No.: 10/397,702

(22) Filed: Mar. 26, 2003

(51) Int. Cl. A23L 1/27

(52) U.S. Cl. 426/540

(57) ABSTRACT

The present invention relates to a novel composition for stabilizing pink color of fresh large cardamom, said composition comprising aqueous solution of chemicals selected from hydrochloric acid, aluminium chloride, trisodium phosphate, organic acids or combinations thereof at a concentration in the range of 0.05 to 2.0 per cent and a process for stabilizing stabilizing pink color of fresh large cardamom using said composition.

### FIELD OF THE INVENTION

The present invention relates to a novel composition for stabilizing pink color of fresh large cardamom, a process for the preparation of colour stabilizing composition and a process for stabilizing the pink color of the large cardamom using the color stabilizing composition.

### BACKGROUND AND PRIOR ART DESCRIPTION

Large cardamom belongs to the Zingiberaceae family. It is native to the Eastern Himalayan region. In India, it is cultivated in Sikkim, Darjeeling and Assam hills. Sikkim is the largest producer of large cardamom in India. According to a recent estimate (1997-98) annual production of large cardamom in India is 5265 tonnes and the export is 1648 tonnes valued at Rs 1265 lakhs. The present average domestic price at the assembling centres varies from Rs. 100 to 150 per kg, depending on quality.

The cured large cardamom capsules on an average contain 70% seeds and 30% husk. The seeds contain 12-14% moisture, 2.0-2.5% volatile oil, 9.9-10.0% protein, 10.0-17.61% crude fibre, 6.0-14.9% carbohydrate, and 3.6-4.4% ash. The quality of large cardamom is determined by the external colour and texture of the capsules and essential oil content in the seeds. The fresh capsules immediately after harvest are pinkish red in colour and contain around 1 per cent anthocyanin pigment in the husk on a dry (moisture free) basis. The anthocyanins reported are cyanidin 3-glucoside and cyanidin-3,5-diglucoside, present in the ratio of 2:1 [Pura Naik et al.,. Journal of Food Science & Technology, 36 (4), 358-360 (1999)]. At the market place, dry capsules with an attractive pink red colour, soft texture and good aroma fetches a premium price.

Anthocyanins occur in the vacuolar sap of plant cells. As glycosides of anthocyanidins they have a flavillium structure. They are water soluble and being highly reactive, are readily oxidised or reduced, the glycoside linkages undergoing hydrolyses. They may also form salts with acids or bases. These pigments are responsible for many of the wide range of red, blue and purple hues of fruits and vegetables as well as flowers. The most common forms of anthocyanidins are pelargonidin, cyanidin, delphinidin, peonidin, malvidin and petunidill. The colour depends on the number and orientation of hydroxyl and methyl groups. An increase in hydroxylation leads to an increase in the red shade.

Anthocyanins together with the colourless leucoanthocyanidins, can take part in colour-forming reactions. Anthocyanins are more stable in an acidic environment than in neutral or alkaline ones. Generally, cyanidin pigment exists at pH 1 to 3 as the red oxonium ion, while in the hydrated form between pH 3 and 7 as a colourless pseudobase. At above 7 pHs the anhydro base is formed, which ionises above pH 10 to become blue anhydro base salt. The hyperchromic effects of organic acids in raspberry juice increased in the order formic>acetic acid>propionic acid>butyric acid.

Metal complexes arise when anthocyanins react with aluminium, tin, copper and iron. Addition of Fe³⁻ and Al³⁺ improved the stability of anthocyanins in the crowberry. Studies involving model systems of various metals and chlorine with cyanidin 3-glucoside have shown formation of yellow to pink colours.

Other factors controlling cyanic colour include: reversible bleaching reactions, the binding of anthocyanins to macromolecules, such as pectins and the strong interactions at acidic pHs with proteins, which cause a colour shift from red to blue (Food Colour and Appearance, John B. Hutchings, Blackie Academic & Professionals London—1994).

At the time of harvesting, large cardamom capsules are bright pink in colour. During the curing [‘bhatti’, flue-curing etc.] process, which involves long hours of drying, the capsules lose much of the pink colour and turn dark brown or grey, which lowers the price of the commodity. The capsules with bright pink colour fetches a better price in the market. Hence a method for the stabilization of pink colour of the freshly harvested large cardamom capsules before subjecting to curing process, was required to be developed.

At present, there are no methods or processes reported in patent or other scientific literatures or as commercially practised, for the stabilization of pink colour of large cardamom capsules.

### OBJECTS OF THE PRESENT INVENTION

The main object of the present invention is to provide a composition for stabilizing pink color of fresh large cardamom.

Another object of the present invention is to provide a process for stabilizing the pink color of fresh large cardamom that can be adopted at the farm or factory level.

### DETAILED DESCRIPTION OF THE PRESENT INVENTION

Accordingly, the present invention provides a composition for stabilizing pink color of fresh large cardamom, said composition comprising aqueous solution of chemicals selected from hydrochloric acid, aluminium chloride, trisodium phosphate, organic acids or combinations thereof at a concentration in the range of 0.05 to 2.0 per cent.

In an embodiment of the present invention, the composition comprises aqueous solution of hydrochloric acid.

In another embodiment of the present invention, the concentration of the aqueous solution of hydrochloric acid is in the range of 0.05 to 0.10 per cent.

In yet embodiment of the present invention, the composition comprises aqueous solution of hydrochloric acid and aluminum chloride.

In still another embodiment of the present invention, the composition comprises 0.1 percent aqueous solution of hydrochloric acid and 0.05 percent aqueous solution of aluminum chloride.

In one more embodiment of the present invertion, the composition comprises aqueous solution of trisodium phosphate and organic acids.

In one another embodiment of the present invention, the organic acid is selected from the group comprising of citric acid, malic acid and acetic acid.

In a further embodiment of the present invention, the organic acid is citric acid.

In an embodiment of the present invention, the formulation comprises 0.25 percent trisodium phosphate and 0.25 percent citric acid.

The present invention also provides a process for stabilizing pink color of fresh large cardamom, said process comprising treating the fresh large cardamom with minimum lapse of time after harvesting with a desired quantity of a composition comprising aqueous solution of chemicals selected from hydrochloric acid, aluminium chloride, trisodium phosphate, organic acids or combinations thereof at a concentration in the range of 0.05 to 2.0 per cent.

In an embodiment of the present invention, aqueous solution of hydrochloric acid is employed as the color stabilizing composition.

In another embodiment of the present invention, the concentration of the aqueous solution of hydrochloric acid is in the range of 0.05 to 0.10 per cent.

In yet another embodiment of the present invention, aqueous solution of hydrochloric acid and aluminum chloride-is used as the color stabilizing composition.

In still another embodiment of the present invention, 0.1 percent aqueous solution of hydrochloric acid and 0.05 percent aqueous solution of aluminum chloride is used as color stabilizing composition.

In one more embodiment of the present invention, the aqueous solution comprising of trisodium phosphate and organic acids is used as the color stabilizing composition.

In one another embodiment of the present invention, the organic acid is selected from the group comprising of citric acid, malic acid and acetic acid.

In a further embodiment of the present invention, the organic acid is citric acid.

In an embodiment of the present invention, 0.25 percent trisodium phosphate and 0.25 percent citric acid is employed as color stabilizing agent.

In another embodiment of the present invention, the ratio between the stabilized composition and fresh large cardamom is in the range of 1:2 to 1:4.

In yet another embodiment of the present invention, the fresh large cardamom is treated with the stabilized composition for a time period in the range of 5 to 30 minutes.

Particularly, the present invention provides a process for stabilizing pink color of fresh large cardamom, said process comprising the steps of:

(a) treating the fresh large cardamom with 2 to 4 times the quantity of a composition comprising aqueous solution of chemicals selected from hydrochloric acid, aluminium chloride, trisodium phosphate, organic acids or combinations thereof for a time period in the range of 5 to 30 minutes;

(b) separating the treated cardamom from the composition and drying the cardamom to remove free surface moisture from;

(c) indirectly heating the dried cardamom of step (b) at a temperature of 50 to 60° C. for a time period of 20 to 30 hours to obtain color stabilized cardamom having desired moisture level.

In an embodiment of the present invention wherein in step (b), the free surface moisture is removed from the cardamom by subjecting the cardamom to natural aeration.

In another embodiment of the present invention wherein in step (c), the dried cardamom is heated using flue gas.

In yet another embodiment of the present invention wherein in step (c), the dried cardamom is heated to attain moisture content in the level of 10-12 percent.

More particularly, the present invention provides a process stabilization of pink color of large cardamom, said process comprising the steps of:

(a) preparation of an aqueous composition using chemicals selected from concentrated hydrochloric acid, aluminium chloride, trisodium phosphate, and organic acids like citric, malic or acetic acid and mixtures thereof at a concentration of 0.05 to 2.0 per cent;

(b) treating ripe red fresh large cardamom capsules, preferably capsules with minimum lapse of time after harvesting with the colour stabilizing solution of step (a);

(c) the above treatments being carried out in a batch process by soaking the cardamom capsules in the solution at a material to solvent ratio of 1:2 to 1:4, for a time period in the range of 5-30 min or alternatively the above stabilization treatment being carried by in a continuous process wherein the residence period of the fresh capsules in the color stabilizing solution is adjusted for a time period ranging between 5-30 min;

(d) removing the treated and colour stabilized capsules from the soaking solution and removing free surface moisture by subjecting the capsules to natural aeration by spreading out in shade or by blowing air through the bed of capsules, and

(e) subjecting the color stabilized capsules to drying by the process of indirect heating i.e. flue-curing at a temperature of 50-60° C. for a period of 20-30 hr. to attain a safe moisture level of around 10-12 per cent, to obtain dry capsules having attractive pink color.

Novelty

1. Colour stabilizer formulations consisting of a solution of concentrated hydrochloric acid, aluminium chloride, trisodium phosphate, and organic acids like citric, malic or acetic acid useful in the preparation of colour stabilized large cardamom capsules.

2. Pink colour of the husk of large cardamom capsules due to anthocyanin is stabilized using selected chemicals in very low concentrations.

3. Selected chemicals are HCl, AlCl₃, organic acids such as citric acid trisodium phosphate or a suitable combinations of those chemicals which are all considered safe for use in food processing.

General Method of Preparation of Fresh Capsules for Acid Treatment

The capsules turning pinkish red is the indication of harvest maturity. The spikes are harvested carefully with a special sickle and pooled at a clean place. The capsules from the spikes are separated manually without damaging the surface. Further the capsules are washed with water to remove the soil or dirt adhering to the surface. The washed capsules are air dried on a clean surface preferably over bamboo mats to remove the surface moisture.

The following examples are given by way of illustration of the present invention and should not be construed to limit the scope of the present invention in any manner.

### EXAMPLE 1

(a) Twenty litres of 0.05% HCl solution in water was prepared in a 30 litres SS vessel. Pre-cleaned 10 kg fresh capsules were transferred into this solution and soaked for 10 min. with gentle stirring at 5 min. intervals. The treated capsules were then removed from the solution and were air-dried on a bamboo mat for 1 hr. to remove the free surface moisture. The capsules were then dried in a flue-curing house for 24 hr. at 50-60° C. temperature to get 2 kg capsules having moisture content of 12 per cent.

Anthocyanin content of the husk was 650 mg per cent. The capsules possessed attractive pinkish red colour.

(b) In a control batch without colour stabilisation treatment and with similar drying conditions, the yield of capsules was 2.0 kg from 10 kg fresh capsules. The colour content in the dry husk was 400 mg per cent.

(c) The dry capsules from untreated and colour stabilized batch were packed in polyethylene bags which were placed in tin container, and stored at ambient conditions. After one year storage, the treated capsules contained anthocyanin at a level more than twice (342 mg per cent) that of control (154 mg per cent) samples.

### EXAMPLE 2

Ten kg fresh cleaned capsules were transferred into a vessel containing 20 litres of 0.1% HCl solution and soaked for 10 min. with stirring every 5 minutes. The treated capsules were then removed from the solution and were air-dried on bamboo mat for 1 hr. to remove surface moisture. The treated air-dried capsules were dried in an electrical cross-flow drier for 18 hr. at 55±5° C. temperature to 13 per cent moisture level. The anthocyanin content of the husk was 0.6 mg/100 g i.e. 600 mg per cent.

### EXAMPLE 3

Twenty litres of 0.25 percent trisodium phosphate and 0.25 per cent citric acid solution was prepared in a 30 L SS vessel. Pre-cleaned fresh capsules (10 kg) were transferred into the vessel and soaked for 20 minutes with stirring every five minutes. The capsules were removed from the solution and spread over clean surface for one hr. These treated capsules were then dried in a electrical cross-flow drier, at 55±5, temperature for 18 hrs yielded 2 kg dry capsules of pinkish red colour. The colour content of the husk was 0.45 mg/100 g.

### EXAMPLE 4

Twenty litre of aqueous solution containing 0.1 percent HCl and 0.05 per cent aluminium chloride (AlCl₃ 6H₂O), was prepared in a 30 L SS vessel. Ten kg pre-cleaned fresh capsules were transferred into vessel containing the acidic AlCl₃ solution and soaked for 10 min. The treated capsules were removed from the solution and spread over a bamboo mat one hr. Further, the colour stabilised capsules were dried in a flue-curing system for 24 hr. to get 1.95 kg dry capsules of 13 percent moisture content. The colour content of the husk was 500 mg/100 g. Following tables (1 & 2) clearly bring out the effect of the colour stabilizing treatments immediately after drying and during storage.

Storage Studies

TABLE 2
Large cardamom storage behaviour of colour stabilized
and untreated (control) samples

| Storage | Infestation | Moisture | % Volatile | Colour |
|---|---|---|---|---|
| period in | % | % in | oil | mg/100 g |
| days | capsules | seeds | (v/w) | husk |
| Control | | | | |
| Initial | Nil | 13.0 | 3.0 | 400 |
| 90 | Nil | 12.7 | 3.0 | 377 |
| 180 | 12.00 | 12.8 | 3.0 | 302 |
| 270 | 29.00 | 12.5 | 2.9 | 254 |
| 365 | 100.00 | 12.5 | 2.9 | 154 |
| Treated | | | | |
| Initial | Nil | 13.0 | 3.0 | 650 |
| 90 | Nil | 12.7 | 3.0 | 530 |
| 180 | Nil | 12.0 | 3.0 | 480 |
| 270 | Nil | 12.0 | 3.0 | 373 |
| 365 | Nil | 12.0 | 3.0 | 342 |

The main advantages of the present invention are the following:

(1) The process delivers dry large cardamom capsules with attractive pinkish red colour which fetches a better price in the market

(2) The colour stabilization treatment can be conveniently practised at the farm level

(3) There is reduction in drying time of the capsules

(4) During storage, the retention of pink colour is better in colour stabilized capsules than in control samples

(5) There is improved keeping quality and resistance to insect infestation.

TABLE 1
Large cardamom - comparative quality profile of
colour-stabilized and untreated (control) samples.

| | | L.C. [colour stabilized] | | | |
|---|---|---|---|---|---|
| Analytical | L.C. | Example 1 | Example 2 | Example 3 | Example 4 |
| Parameters | [Control] | (0.05% HCl) | (0.1% HCl) | (0.25% TSP + 0.25% CA) | (0.1% HCl + 0.05% AlCl₃) |
| Moisture [%] | 13.0 | 12.0 | 11.0 | 13.0 | 13.0 |
| Volatile oil [%] | 3.0 | 3.0 | 3.0 | 2.9 | 2.9 |
| Total acidity [%] | 0.4 | 0.4 | 0.4 | 0.4 | 0.4 |
| PH [%] | 4.3 | 4.3 | 4.3 | 4.3 | 4.3 |
| Colour [%] Anthocyanin | 0.4 | 0.6 | 0.65 | 0.45 | 0.50 |
| mg/100 g husk mfb | | | | | |

It can seen that 0.05% aqueous HCl treatment for 10 min. was sufficient to deliver a colour stabilized product. The colour stabilization was also relatively same compared to 0.1% aqueous HCl treatment for 10 min.

1. A composition for stabilizing pink color of fresh large cardamom, said composition comprising aqueous solution of chemicals selected from hydrochloric acid, aluminium chloride, trisodium phosphate, organic acids or combinations thereof at a concentration in the range of 0.05 to 2.0 per cent.

2. A composition as claimed in claim 1, wherein the composition comprises aqueous solution of hydrochloric acid.

3. A composition as claimed in claim 2, wherein the concentration of the aqueous solution of hydrochloric acid is in the range of 0.05 to 0.10 per cent.

4. A composition as claimed in claim 1, comprising aqueous solution of hydrochloric acid and aluminum chloride.

5. A composition as claimed in claim 4 comprising 0.1 percent aqueous solution of hydrochloric acid and 0.05 percent aqueous solution of aluminum chloride.

6. A composition as claimed in claim 1 comprising aqueous solution of trisodium phosphate and organic acids.

7. A composition as claimed in claim 6, wherein the organic acid is selected from the group comprising of citric acid, malic acid and acetic acid.

8. A composition as claimed in claim 7, wherein the organic acid is citric acid.

9. A composition as claimed in claim 7, wherein the formulation comprises 0.25 percent trisodium phosphate and 0.25 percent citric acid.

10. A process for stabilizing pink color of fresh large cardamom, said process comprising treating the fresh large cardamom with minimum lapse of time after harvesting with a desired quantity of a composition comprising aqueous solution of chemicals selected from hydrochloric acid, aluminium chloride, trisodium phosphate, organic acids or combinations thereof at a concentration in the range of 0.05 to 2.0 per cent.

11. A process as claimed in claim 10, wherein aqueous solution of hydrochloric acid is employed.

12. A process as claimed in claim 11, wherein the concentration of the aqueous solution of hydrochloric acid is in the range of 0.05 to 0.10 per cent.

13. A process as claimed in claim 11, wherein aqueous solution of hydrochloric acid and aluminum chloride is used.

14. A process as claimed in claim 13, wherein 0.1 percent aqueous solution of hydrochloric acid and 0.05 percent aqueous solution of aluminum chloride is used.

15. A process as claimed in claim 11, wherein the aqueous solution comprising of trisodium phosphate and organic acids.

16. A process as claimed in claim 15, wherein the organic acid is selected from the group comprising of citric acid, malic acid and acetic acid.

17. A process as claimed in claim 15, wherein the organic acid is citric acid.

18. A process as claimed in claim 15, wherein 0.25 percent trisodium phosphate and 0.25 percent citric acid is employed.

19. A process as claimed in claim 11, wherein the ratio between the stabilized composition and fresh large cardamom is in the range of 1:2 to 1:4.

20. A process as claimed in claim 11, wherein the fresh large cardamom is treated with the stabilized composition for a time period in the range of 5 to 30 minutes.

21. A process for stabilizing pink color of fresh large cardamom, said process comprising the steps of:
(d) treating the fresh large cardamom with 2 to 4 times the quantity of a composition comprising aqueous solution of chemicals selected from hydrochloric acid, aluminium chloride, trisodium phosphate, organic acids or combinations thereof for a time period in the range of 5 to 30 minutes;
(e) separating the treated cardamom from the composition and drying the cardamom to remove free surface moisture from;
(f) indirectly heating the dried cardamom of step (b) at a temperature of 50 to 60° C. for a time period of 20 to 30 hours to obtain color stabilized cardamom having desired moisture level.

22. A process as claimed in claim 21 wherein in step (b), the free surface moisture is removed from the cardamom by subjecting the cardamom to natural aeration.

23. A process as claimed in claim 21 wherein in step (c), the dried cardamom is heated using flue gas.

24. A process as claimed in claim 21 wherein in step (c), the dried cardamom is heated to attain moisture content in the level of 10-12 percent.

25. A process stabilization of pink color of large cardamom, said process comprising the steps of:
(f) preparation of an aqueous composition using chemicals selected from concentrated hydrochloric acid, aluminium chloride, trisodium phosphate, and organic acids like citric, malic or acetic acid and mixtures thereof at a concentration of 0.05 to 2.0 per cent;
(g) treating ripe red fresh large cardamom capsules, preferably capsules with minimum lapse of time after harvesting with the colour stabilizing solution of step (a);
(h) the above treatments being carried out in a batch process by soaking the cardamom capsules in the solution at a material to solvent ratio of 1:2 to 1:4, for a time period in the range of 5-30 min or alternatively the above stabilization treatment being carried by in a continuous process wherein the residence period of the fresh capsules in the color stabilizing solution is adjusted for a time period ranging between 5-30 min;
(i) removing the treated and colour stabilized capsules from the soaking solution and removing free surface moisture by subjecting the capsules to natural aeration by spreading out in shade or by blowing air through the bed of capsules, and
(j) subjecting the color stabilized capsules to drying by the process of indirect heating i.e. flue-curing at a temperature of 50-60° C. for a period of 20-30 hr. to attain a safe moisture level of around 10-12 per cent, to obtain dry capsules having attractive pink color.
